(19) United States
(12) Patent Application Publication
(10) Pub. No.: US 2007/0106616 A1
(43) Pub. Date: May 10, 2007

(54) License information management apparatus and license information management method

(76) Inventor: Motoji Ohmori, (US)

Correspondence Address: WENDEROTH, LIND & PONACK L.L.P., 2033 K. STREET, NW, SUITE 800, WASHINGTON, DC, 20006, US

(21) Appl. No.: 10/579,558

(22) PCT Filed: Feb. 7, 2005
(86) PCT No.: PCT/JP05/02110

§ 371 Date: May 16, 2006

(51) Int. Cl. G06Q 99/00

(52) U.S. Cl. 705/59

(57) ABSTRACT

This invention provides a license information management apparatus and the like that do not require a tamper resistance module with a large memory even in the case where a user possesses a large amount of content.

A total control unit (113) specifies a content corresponding to a reproduction instruction received from a user (S202). Further, the total control unit (113) verifies whether or not there is a LT corresponding to the specified content in a secure flash unit (120). In the case where there is the LT in the secure flash unit (120) (S203: Yes) and information concerning the reproduction of the content is received from the content decryption unit (520) (S204: Yes), an encryption/decryption unit (114) decrypts the LT stored in the secure flash unit (120) using a is TRM unique key (S205). After that, the encryption/decryption unit (114) updates details of the content reproduction condition information (511a), encrypts the updated details using the TRM unique key, and writes the encrypted TRM unique key into the secure flash unit (120) (S208).

### TECHNICAL FIELD

The present invention relates to a management apparatus of license information which defines key information, reproduction conditions and the like for reproducing encrypted digital contents and the like and to the management method thereof, in particular to a technology of managing the license information while securing tamper resistance.

### BACKGROUND ART

In recent years, a distribution of content (e.g. video, audio, program soft, etc.) using a network such as a broadband has been widely available. Further, a content distribution using a Blue ray Disc-Record Only Memory (BD-ROM) package has been under the review. In general, the content is encrypted so that a user needs to obtain a decryption key corresponding to the content. Furthermore, the use of content is most likely to be restricted based on the premise of fee payment. Therefore, the user needs to use the content in accordance to predetermined license information (e.g. license ticket). Here, the “license ticket” is information including “content reproduction condition information” which defines a condition for restricting the use of content and an encrypted “content key” which is a key for decrypting a received content. The “content reproduction condition information” is, for example, information for defining a date, total amount of time and the number of times that are available for reproduction.

Therefore, a strict management is required for the license ticket. In general, the license ticket is stored in an area (tamper resistant area) in which it cannot be rewritten unless a permission is given (e.g. refer to Japanese Laid-Open Patent application No. H01-194029).

FIG. 1 is a block diagram showing a functional structure of a content reproduction apparatus 500 according to a conventional technology. The content reproduction apparatus 500 is an apparatus which manages a license ticket necessary for reproducing (using) the encrypted content (e.g. in the case of BS digital broadcast, a scramble key, a work key and a master key are used for encrypting the content.), while securing tamper resistance. It includes a tamper resistance module unit (hereafter, referred to as “TRM unit”) 510, a content decryption unit 520, a decode unit 530, and an operation input unit 535. Note that, the content reproduction apparatus 500 may have a communication control unit and the like that is connected to an external network and controls transmitting and receiving data.

The TRM unit 510 is composed of, for example, an IC card having tamper resistance and manages the license ticket. It includes a license storage unit 511 which holds content reproduction condition information 511a and an encrypted content key 511b, a content reproduction condition management unit 512 which controls a content reproduction based on the content reproduction condition information 511a, a TRM unique key storage unit 513 which holds a unique key and the like used in the TRM unit 510, and a content key decryption unit 514 which decrypts the content key using the TRM unique key.

The content decryption unit 520 decrypts a content 550 encrypted with the content key decrypted by the content key decryption unit 514.

The decode unit 530 decodes the content decrypted by the content decryption unit 520 into data which can be displayed to a display 540. The operation input unit 535 is, for example, a switch, a remote control and the like, receives an operation such as “reproduce” from a user and notifies the content decryption unit 520 and the content reproduction condition management unit 512.

An operation of the content reproduction apparatus 500 is as follows.

First, the TRM unit 510 (IC card) obtained from a center 600 is inserted to a card insertion slot and the like (not shown in the diagram) of the content reproduction apparatus 500. When receiving a reproduction instruction from a user via the operation input unit 535, the content reproduction condition management unit 512 specifies a content instructed to be reproduced and, from the license ticket storage unit 511, content reproduction condition information 511a of the license ticket corresponding to the content, and decodes the details. Further, the content reproduction condition management unit 512 judges whether or not the details of the content reproduction condition information 511a are the condition which can be permitted for reproducing the content. When the reproduction is permitted, the content reproduction condition management unit 512 reads out the encrypted content key 511b stored in the license ticket storage unit 511 and transmits to the content key decryption unit 514. The content key decryption unit 514 reads out the TRM unique key from the TRM unique key storage unit 513, decrypts the encrypted content key 511b, and transmits the encrypted content key 511b to the content decryption unit 520. The content decryption unit 520 decrypts the content based on the decrypted content key received from the content key decryption unit 514, and transmits the decrypted content to the decode unit 530.

Further, the content decryption unit 520 transmits information concerning a reproduction of the content (e.g. content name, reproduction starting date, reproduction ending date, etc.) to the content reproduction condition management unit 512. Consequently, the content reproduction condition management unit 512 changes the details of the content reproduction condition information 511a corresponding to the reproduced content, and overwrites on the license ticket storage unit 511. Here, the content key decryption unit 514 and the content decryption unit 520 are connected to each other by a Secure Authentication Channel (SAC).

As described in the above, the content reproduction apparatus 500 manages the license ticket that is reproduction condition information while securing tamper resistance.

However, the license ticket takes a form of “one content one license ticket” to make a distribution of fee easier. When one user possesses a large amount of contents, the number of license tickets accordingly increases as well as an amount of data according to the license tickets. Consequently, it is necessary to have a TRM unit having mass storage increasing the costs of the content reproduction apparatus and causing a decrease of competitiveness.

Accordingly, an object of the present invention is to provide a license management apparatus and a license information management method which do not require the TRM unit having mass storage even in the case where the user possesses a large amount of contents.

### DISCLOSURE OF INVENTION

In order to achieve the object, the license information management apparatus according to present invention is a license information management apparatus which manages license information indicating a range in which digital content can be used, said apparatus comprising: a data management unit operable to manage license information while ensuring security of the license information; and a storage unit operable to hold the license information whose security is ensured, wherein said data management unit includes: a secret key holding subunit operable to hold a secret key; and a reproduction condition management subunit operable to encrypt the license information with the secret key, and to transfer the encrypted license information to said storage unit.

Accordingly, the license information (e.g. license ticket) conventionally stored in said data management unit (e.g. IC card etc.) having tamper resistance is stored into said storage unit (e.g. secure flash unit) so that storage memory in said data management unit is restrained to minimum.

Also, said reproduction condition management subunit further includes: a reading subunit operable to read out the encrypted license information and the secret key respectively from said storage unit and said secret key holding unit; a decryption subunit operable to decrypt the read license information; an information update subunit operable to update the decrypted license information in accordance with a use of digital content; and an overwriting subunit operable to encrypt the updated license information with the secret key and overwrite in said storage unit.

Said storage unit further includes a signature data storage unit operable to hold data indicating a digital signature applied to a correspondence table indicating a correspondence between identification information which can identify the license information and information indicating an update history of the license information, said data management unit further includes a correspondence table storage unit operable to hold the correspondence table, and said reproduction condition management unit is further operable to verify validity of the license information based on the data to which a digital signature is applied stored in said signature data storage unit and the correspondence table stored in said correspondence table storage unit.

Consequently, the license information is stored in said storage unit and validity of the license ticket is examined based on a correspondence table in which information which can identify the license ticket (e.g. LT_ID) and information indicating update history of the license information (e.g. the number of update times) are associated with each other. Therefore, in addition to limit the storage memory of the storage unit to the minimum, the license information can be managed with higher security.

Note that the present invention can be realized as a license information management method having characteristic constituents of the license information management apparatus as steps, or as a program causing a personal computer and the like to execute the steps. Also, not to mention that the program can be widely distributed via a recording medium such as DVD or a transmission medium such as the Internet.

Accordingly, a delivery and circulation of digital copyrighted works via a digital broadcast, package soft, network and the like are encouraged. In a present time when a proper copyright protection is requested, the practical value of the present invention is very high. As further information about technical background to this application, the disclosure of Japanese Patent Application No. 2004-032676 filed on Feb. 9, 2004 including specification, drawings and claims is incorporated herein by reference in its entirety.

### BRIEF DESCRIPTION OF DRAWINGS

These and other objects, advantages and features of the invention will become apparent from the following description thereof taken in conjunction with the accompanying drawings that illustrate a specific embodiment of the invention. In the Drawings:

FIG. 1 is a block diagram showing a functional structure of a content reproduction apparatus according to conventional technology.

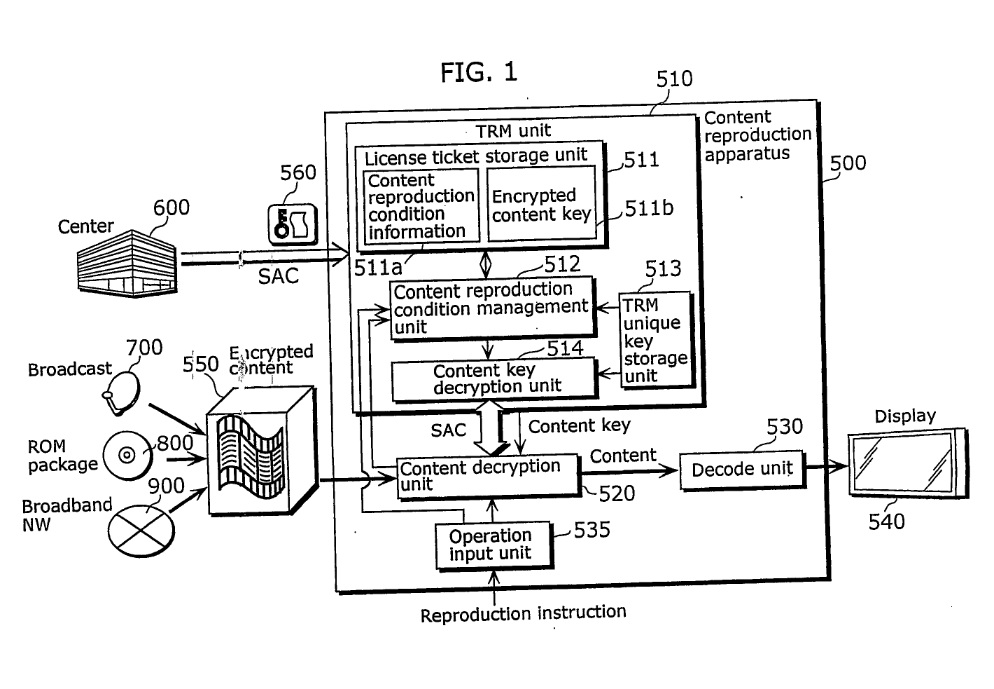

FIG. 2 is a block diagram showing a functional structure of the content reproduction apparatus according to the first embodiment.

FIG. 3 is a diagram showing a functional structure of a content reproduction condition management unit in the first embodiment.

FIG. 4 is a flowchart showing a process of content reproduction condition management unit in the first embodiment.

FIG. 5 is a diagram for explaining a challenge of the content reproduction apparatus in the first embodiment.

FIG. 6 is a block diagram showing a functional structure of a content reproduction apparatus according to the second embodiment.

FIG. 7 is a block diagram showing a functional structure of a content reproduction condition management unit in the second embodiment.

FIG. 8 is a diagram showing an example of a correspondence table in the second embodiment.

FIG. 9 is a flowchart showing a process of the content reproduction condition management unit in the second embodiment.

### BEST MODE FOR CARRYING OUT THE INVENTION

Hereafter, it is explained in detail about embodiments according to the present invention with reference to drawings.

### First Embodiment

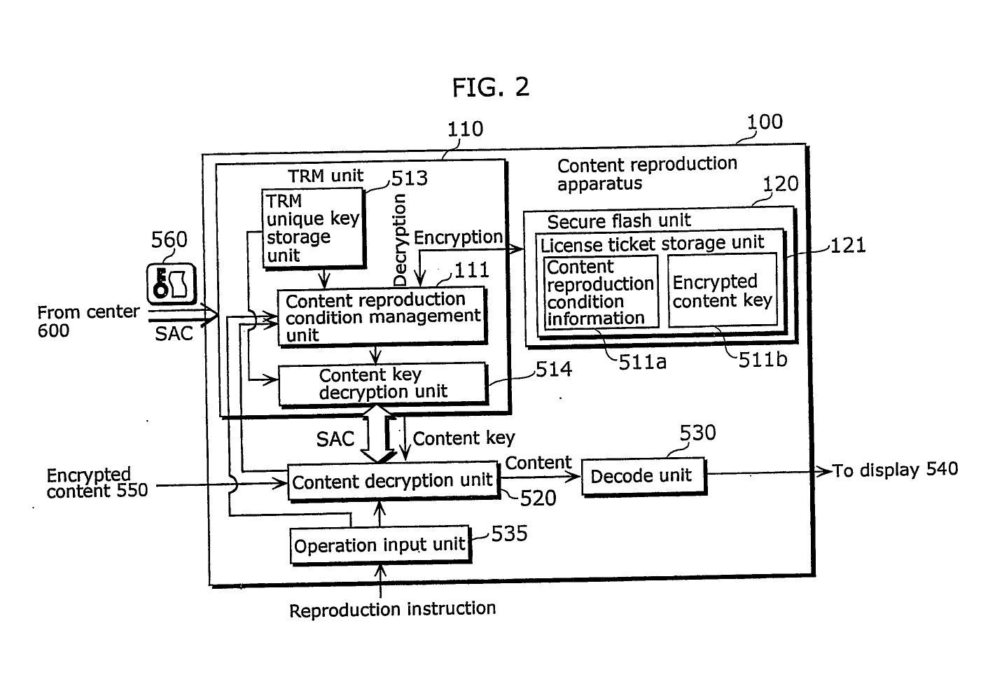

FIG. 2 is a block diagram showing a functional structure of a content reproduction apparatus 100 according to the present embodiment. The content reproduction apparatus 100 in FIG. 2 is an apparatus that manages a license ticket (hereafter referred to as “LT”) necessary for reproducing (using) an encrypted content, while securing tamper resistance. It includes a TRM unit 110, a secure flash unit 120, a content decryption unit 520, a decode unit 530 and an operation input unit 535. Note that, the content reproduction apparatus 100 may have a communication control unit (not shown in the diagram) that is connected to an external network and controls transmitting and receiving of data.

Here, in the content reproduction apparatus 100, same marks are attached to same functional structures as in the conventional content reproduction apparatus 500. Also, descriptions about the same structures are omitted in here.

The TRM unit 110 is, for example an IC card with tamper resistance, having a content reproduction condition management unit 111, a TRM unique key storage unit 513 and a content key decryption unit 514. Here, the TRM unit is an example of a data control unit.

The content reproduction condition management unit 111 is a section where controls the TRM unit 110 as a whole, updates the content reproduction information 511a corresponding to the content every time when the content is reproduced by the user, while encrypting a license ticket corresponding to the encrypted content 550 obtained via the center 600 and storing into the secure flash unit 120.

The secure flash unit 120 is, for example a general flash memory. However, it has a characteristic that a encryption/decryption is performed with the TRM unique key in the case of writing or reading the license ticket corresponding to the content 550 (i.e. the content reproduction condition information 511a and the encrypted content key 511b). Specifically, the content reproduction condition management unit 111 decrypts the license ticket read out from the secure flash unit 120 using the TRM unique key stored in the TRM unique key storage unit 513. Also, it encrypts the updated license ticket using the TRM unique key and writes into the secure flash unit 120. Here, the secure flash unit is an example of a storage unit.

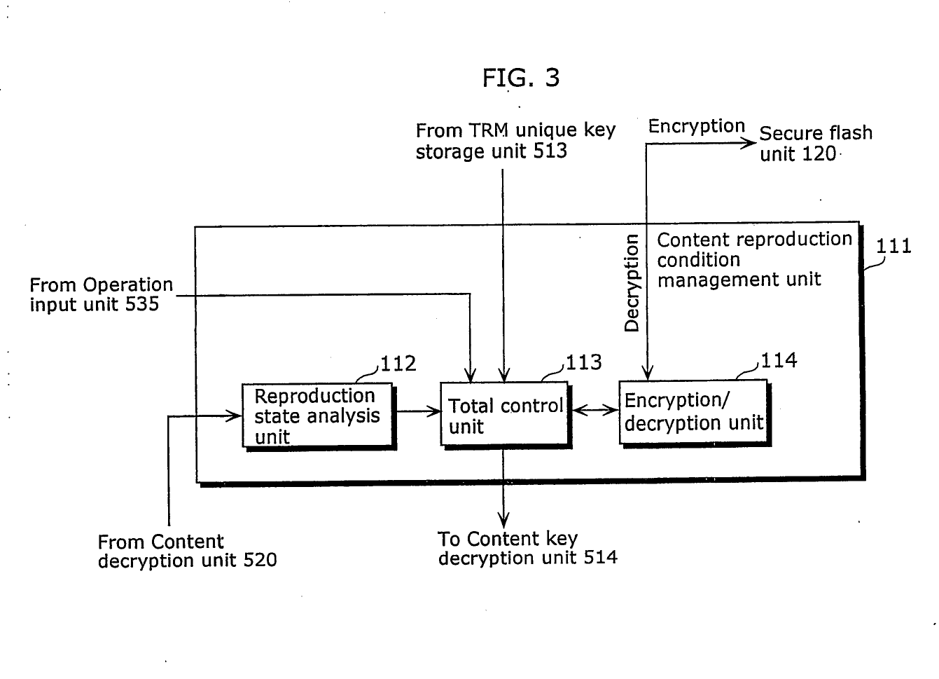

FIG. 3 is a block diagram showing a functional structure of the content reproduction condition management unit 111. As shown in FIG. 3, the content reproduction condition management unit 111 has a reproduction state analysis unit 112, a total control unit 113 and an encryption/decryption unit 114.

The reproduction state analysis unit 112 receives information concerning the content reproduction (e.g. content name, reproduction starting date, reproduction ending date, etc.) from the content decryption unit 520, generates reproduction state information indicating a reproduction state of the content based on the information, and notifies the total control unit 113 of the generated reproduction state information.

The total control unit 113 controls the content reproduction condition management unit 111 as a whole, being, for example, a microcomputer having a ROM and RAM. The total control unit 113 updates and encrypts the content reproduction condition information 511a read out via the encryption/decryption unit 114, and instructs the encryption/decryption unit to overwrite on the secure flash unit 120, based on the reproduction state information received from the reproduction state analysis unit 112. Further, the total control unit 113 reads the TRM unique key stored in the TRM unique key storage unit 513 if necessary and transmits to the encryption/decryption unit 114 and the content key decryption unit 514. Furthermore, the total control unit 113 controls timing of an encryption process or a decryption process in the encryption/decryption unit 114.

In addition, when detecting that the IC card is inserted to the card insertion slot and a license ticket is newly purchased, the total control unit 113 temporary stores the purchased license ticket into the internal RAM and the like. After that, it transfers the license ticket again to the secure flash unit 120 (i.e. storing a new license ticket into the secure flash unit 120 and deleting the license ticket inside the IC card).

Here, as described in the above, it is not limited to the method of detecting that the IC card has been inserted to the card insertion slot, and transferring the newly purchased license ticket to the secure flash unit 120. The license ticket may be obtained using the communication control unit (not shown in the diagram) and the total control unit 113 may detect and transfer to the secure flash unit 120.

The encryption/decryption unit 114, based on the instruction by the total control unit 113, performs reading and decryption process, or encrypting process and writing on the content reproduction condition information 511a for the secure flash unit 120.

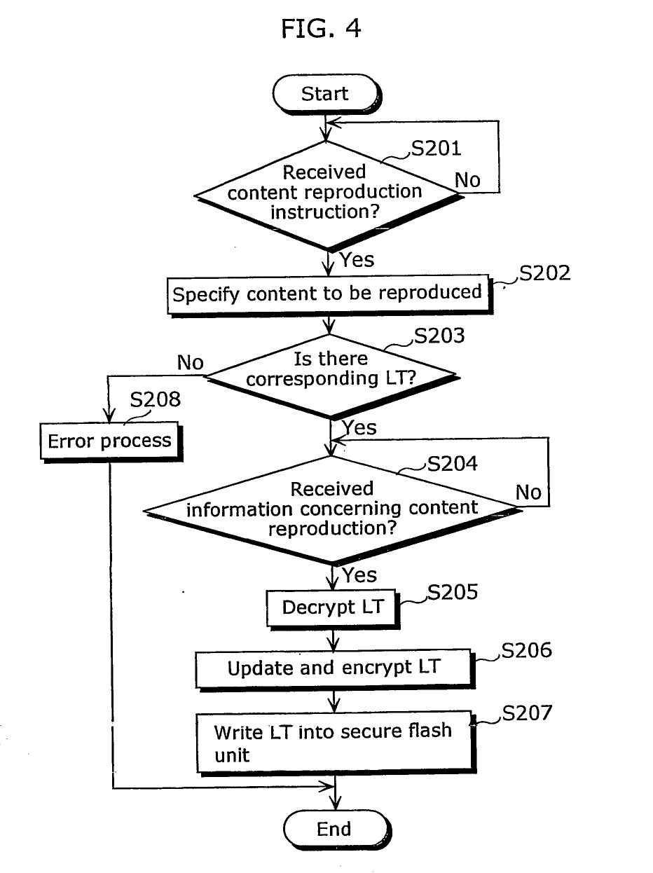

FIG. 4 is a flowchart showing a flow of process in the content reproduction condition management unit 111 shown in FIG. 3.

First, when receiving the instruction to reproduce the content from the user (S201: Yes), the total control unit 113 specifies a content corresponding to the reproduction instruction (S202) via the content decryption unit 520 and the operation input unit 535.

Next, the total control unit 113 verifies whether or not there is a license ticket corresponding to the specified content (i.e. the license ticket has been purchased) (S203). In the case where it is verified, similar to the case of the conventional technology, the total control unit 113 decrypts the content key, and transmits to the content decryption unit 520.

As the method of verifying whether there is the license ticket or not, for example, there is a method of holding information that can identify the license ticket (e.g. ID of license ticket is referred to as “LT_ID”) into the RAM inside the total control unit 113 when the newly purchased license ticket is transferred to the secure flash unit 120, and of verifying whether there is the LT_ID corresponding to the content inside the total control unit 113. If there is no license ticket (S203: No), the total control unit 113 executes an error process (S208).

After that, the total control unit 113 receives information relating to the reproduction of the content from the content decryption unit 520 (5204: Yes), and instructs the encryption/decryption unit 114 to decrypt the license ticket stored in the secure flash unit 120 using the TRM unique key stored in the TRM unique key storage unit 513 (S205).

Further, the total control unit 113 updates details of the content reproduction condition information 511a of the decrypted license ticket, and instructs the encryption and decryption unit 114 to re-encrypt using the TRM unique key (S206). Consequently, the encryption/decryption unit 114 encrypts the updated license ticket and overwrites on the secure flash unit 120 (S207).

As described in the above, according to the content reproduction apparatus in the present embodiment, the license ticket stored in the conventional TRM unit (IC card with tamper resistance) is stored in the secure flash unit so that a storage memory of the TRM unit can be restrained to the minimum.

### Second Embodiment

In the first embodiment, it is explained an example that the license ticket corresponding to the content is stored in the secure flash unit and an increase of the storage memory of the TRM unit is prevented. In this embodiment, it is explained further an example to prevent the license ticket stored in the secure flash unit to be rewritten without permission.

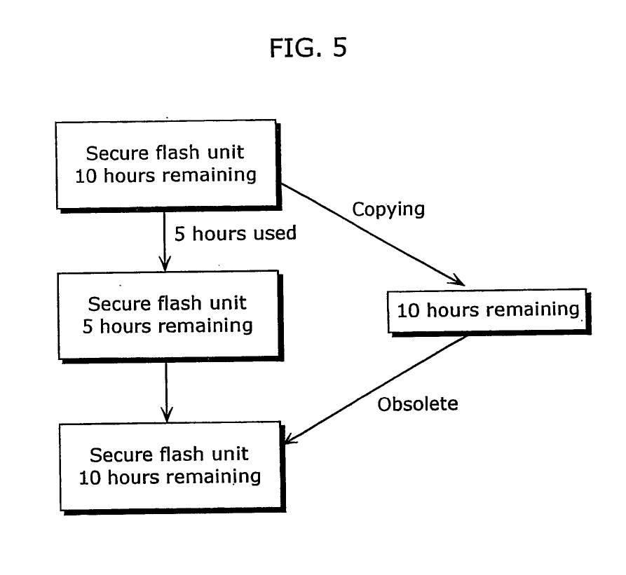

FIG. 5 is a diagram for explaining a state where the license ticket stored in the secure flash unit is rewritten without permission. As shown in FIG. 5, for example, in the case where a license ticket for admitting a reproduction of maximum “10 hours” is set for a content, if the content is reproduced for 5 hours, the remaining reproduction permitted time should be “5 hours”. However, since the secure flash unit 120 is a general memory, it can arbitrary read and write so that it can copy data of the license ticket showing “10 hours” before the reproduction on the other memory area and can rewrite the data of the old license ticket again showing “10 hours” after the content is reproduced for 5 hours.

Here, in the present invention, it is explained about a content reproduction apparatus which holds a correspondence table of LT_ID to the number of update times of the license ticket inside the TRM and prevents the unauthorized activities, based on the correspondence table.

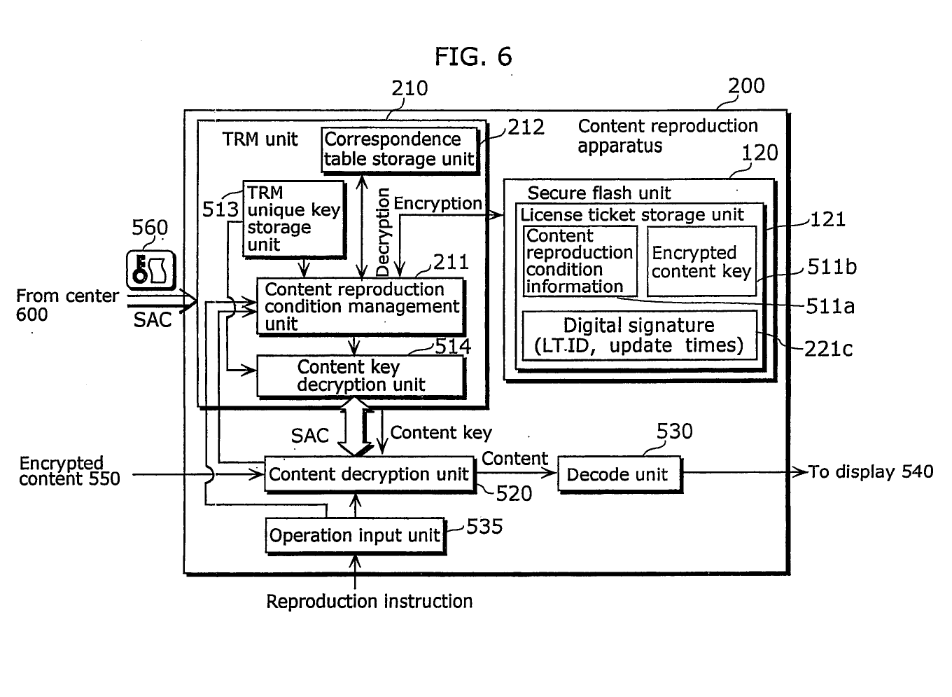

FIG. 6 is a block diagram showing a functional structure of the content reproduction apparatus 200 according to the present embodiment. Note that, in the content reproduction apparatus 200, same marks are attached to the same functional structures as in the content reproduction apparatus 100 in the first embodiment. In addition, the description about same structure is omitted in here.

As shown in FIG. 6, the TRM unit 210 of the content reproduction apparatus 200 further has a correspondence table storage unit 212 for storing the correspondence table. Furthermore, the content reproduction condition management unit 211 of the content reproduction apparatus 200 prevents unauthorized rewriting of the license ticket based on the correspondence table stored in the correspondence table storage unit 212.

Also, the secure flash unit 120 stores data 221c to which a digital signature for a concatenated data between the LT_ID and a number of update times of license ticket is newly applied.

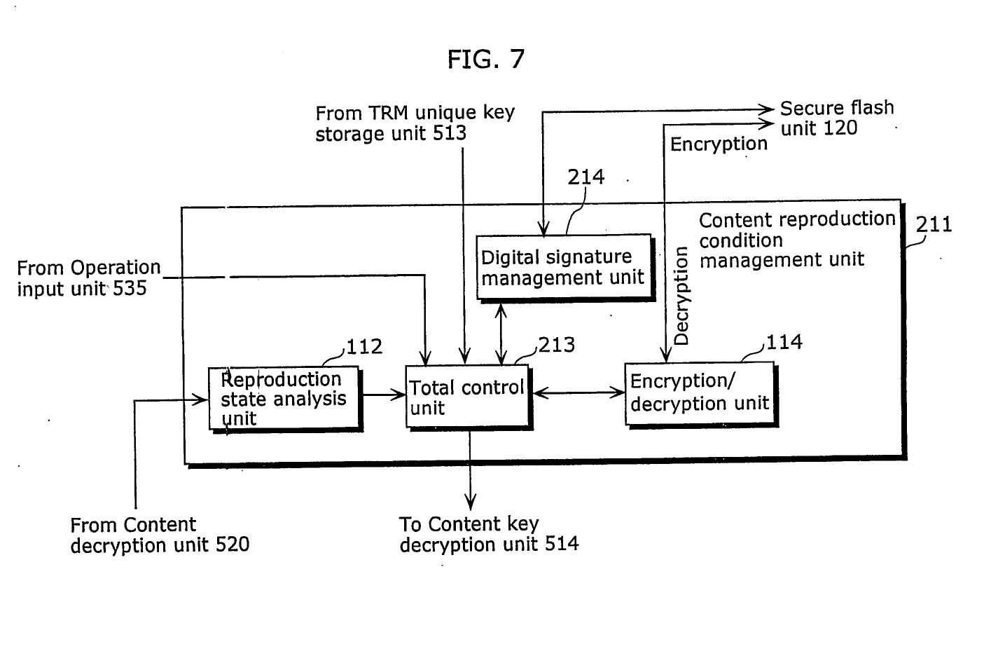

FIG. 7 is a block diagram showing a functional structure of the content reproduction condition management unit 211. As shown in FIG. 7, the content reproduction condition management unit 211 has a reproduction state analysis unit 112, a total control unit 213, an encryption/decryption unit 114 and a digital signature management unit 214.

The total control unit 213 is a section where controls the content reproduction condition management unit 211 as a whole. For example, it is a micro computer having a ROM and RAM. In addition to the function of the total control unit 113 in the first embodiment, the total control unit 213 controls the digital signature management unit 214. Further, the total control unit 213 creates information of a pair of the LT_ID and the number of update times (hereafter referred to as “concatenated information”).

The digital signature management unit 214, based on an instruction from the total control unit 213, applies a digital signature to the concatenated information, stores into the secure flash unit 120, reads out the concatenated information stored in the secure flash unit 120 and verifies the validity. Here, conventional technology is used for a method of applying the digital signature and applying it.

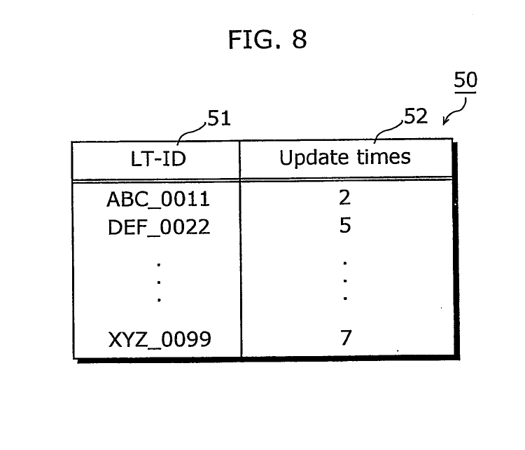

Hereafter, it is explained about a method used by the total control unit 213 for preventing the old license ticket from being rewritten based on the correspondence table with reference to the following FIG. 8.

FIG. 8 is an example of a correspondence table stored in the correspondence table storage unit 212. As shown in FIG. 8, the LT_IDs and the number of update times are associated with each other and stored in the correspondence table 50. Accordingly, if the total control unit 213 manages the license ticket (e.g. a license ticket called “ABC_{—}0011”) so as to increment the number of update times, it can verify whether or not the concatenated information is rewritten without permission by collating the concatenated information stored in the TRM unit 210 with the concatenated information stored in the secure flash unit 120.

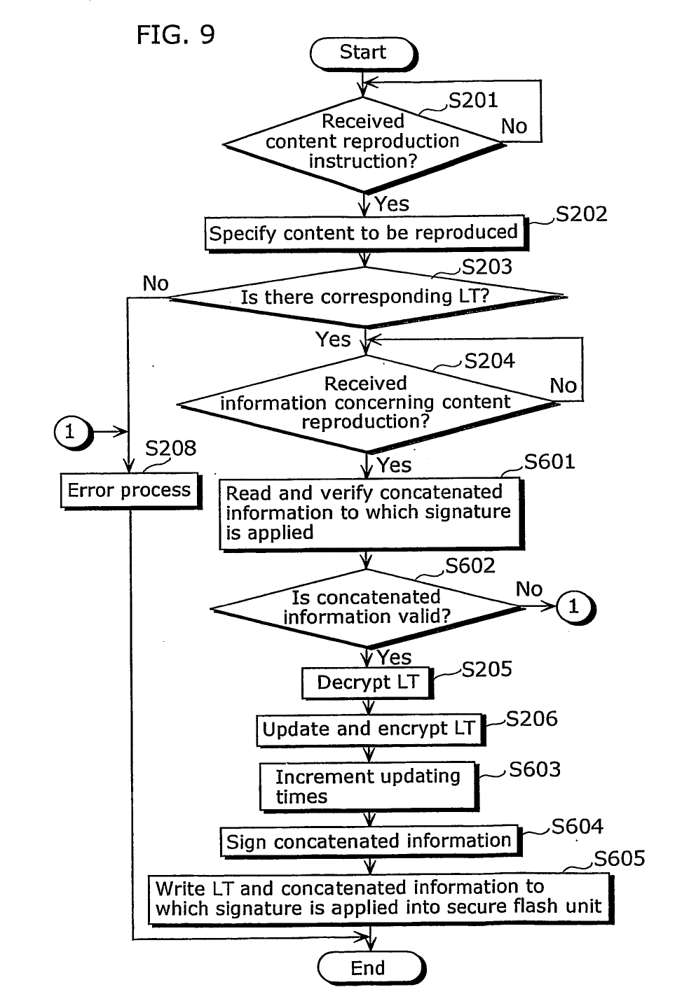

FIG. 9 is a flowchart showing a process of the content reproduction condition management unit 211 in the present embodiment. Here, same marks are attached to the same process shown in the flowchart of FIG. 4 in the first embodiment and the description about the same process is omitted.

First, the total control unit 2,13, similar to the case in the first embodiment, verifies the existence of the license ticket corresponding to the content according to the reproduction instruction (S203: Yes), when receiving information concerning the reproduction of the content from the content decryption unit 520 (S206: Yes), reads out the concatenated information to which the digital signature is applied, being stored in the secure flash unit 120, and instructs the digital signature management unit 214 to verify the validity using the TRM unique key (S601). Then, when the concatenated information is verified (S602: Yes), the total control unit 213 instructs the encryption/decryption unit 114 to decrypt the license ticket (S205).

Further, the total control unit 213 updates details of LT including the content reproduction condition information 511a and instructs the encryption/decryption unit 114 to re-encrypt the updated LT using the TRM unique key (S206). Furthermore, the total control unit 213 increments the number of update times (S603) and instructs the digital signature management unit 214 to apply the digital signature to the concatenated information (S604). It then instructs the encryption/decryption unit 114 and the digital signature management unit 214 so as to write the encrypted LT and the concatenated information to which the digital signature is applied (S605).

Here, in the second embodiment, the number of update times is used to explain as information to be associated with the LT_ID. However, it is not limited to the number of update times. It may be information such as random numbers that can identify an event which has performed update.

Also, in the second embodiment, it is explained as an example that the correspondence table is held in the TRM unit. However, the correspondence table may be also stored in the secure flash unit and hush value in the correspondence table may be held in the TRM unit. Furthermore, digital signature or hush value for each license ticket is stored in the secure flash unit, and the hush value may be stored in the TRM unit. Note that, the reproduction condition (e.g. validity period for reproduction) that is not necessary to be updated in the content reproduction condition information of the license ticket is not provided on the correspondence list. Instead, the memory storage may be reduced As described in the above, according to the content reproduction apparatus in the present embodiment, while storing the license ticket into the secure flash unit, the validity of the license ticket is examined based on the correspondence table in which the information (LT_ID) which can identify the license ticket with the number of update times. Therefore, the storage memory of the TRM unit is restrained at minimum and the license ticket can be managed with higher security.

Further, in the first and second embodiments, the content decryption unit is set outside the TRM unit. However, it may be set inside the TRM unit.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The license information management apparatus and the license information management method according to the present invention can be used for a reproduction apparatus of package contents such as a DVD reproduction apparatus which can reproduce encrypted content that requires a copyright protection, for a personal computer which receives and reproduces, via a network, the encrypted content, and the like.

1. A license information management apparatus which manages license information indicating a range in which digital content can be used, said apparatus comprising:
a data management unit operable to manage license information while ensuring security of the license information; and
a storage unit operable to hold the license information whose security is ensured,
wherein said data management unit includes:
a secret key holding subunit operable to hold a secret key; and
a reproduction condition management subunit operable to encrypt the license information with the secret key, and to transfer the encrypted license information to said storage unit.

2. The license information management apparatus according to claim 1,
wherein said reproduction condition management subunit further includes:
a reading subunit operable to read out the encrypted license information and the secret key respectively from said storage unit and said secret key holding unit;
a decryption subunit operable to decrypt the read license information;
an information update subunit operable to update the decrypted license information in accordance with a use of digital content; and
an overwriting subunit operable to encrypt the updated license information with the secret key and overwrite in said storage unit.

3. The license information management apparatus according to claim 2,
wherein said storage unit further includes
a signature data storage subunit operable to hold data indicating a digital signature applied to a correspondence table indicating a correspondence between identification information which can identify the license information and information indicating an update history of the license information,
said data management unit further includes
a correspondence table storage subunit operable to hold the correspondence table, and
said reproduction condition management subunit is further operable to verify validity of the license information based on the data to which a digital signature is applied stored in said signature data storage unit and the correspondence table stored in said correspondence table storage unit.

4. The license information management apparatus according to claim 3,
wherein the information indicating the update history indicates a number of updates or a random number,
said information update subunit is further operable to update the information indicating the number of updates or the random number when updating the license information, and
said overwriting subunit is further operable to overwrite the correspondence table concerning the information indicating the updated number of updates or the random number in said storage unit.

5. The license information management apparatus according to claim 4,
wherein the digital content is encrypted, and
the license information includes:
reproduction condition information defining a condition indicating a range in which the digital content can be used; and
a content key for decrypting the digital content.

6. The license information management apparatus according to claim 5,
wherein said data management unit includes
an information judgement subunit operable to judge whether the license information is new or not, and
said reproduction condition management subunit is operable to perform the encryption and the transfer of the license information which is judged as new.

7. The license information management apparatus according to claim 5,
wherein said data management unit is made up of an integrated circuit card, and
said storage unit is made up of a flash memory.

8. A license information management method for managing license information indicating-a range in which digital content can be used, the method comprising
managing license information while ensuring security of the license information,
wherein said managing includes
encrypting the license information with a secret key stored in a secret key holding unit, and transferring the encrypted license information to a storage unit operable to hold the license information whose security is ensured.

9. The license information management method according to claim 8,
wherein said encrypting and transferring further includes:
reading the encrypted license information and the secret key respectively from the storage unit and the secret key holding unit;
decrypting the read license information;
updating the decrypted license information in accordance with a use of digital content; and
encrypting the updated license information with the secret key and overwriting in the storage unit.

10. The license information management method according to claim 9,
wherein the storage unit further includes
a signature data storage subunit operable to hold data indicating a digital signature applied to a correspondence table indicating a correspondence between identification information which can identify the license information and information indicating an update history of the license information, and
further in said encrypting and transferring,
validity of the license information is verified based on data to which a digital signature is applied stored in the signature data storage unit and the correspondence table.

11. A computer executable program used for a license information management apparatus which manages license information indicating a range in which digital content can be used, the program comprising:
managing license information while ensuring security of the license information;
said managing includes
encrypting the license information with a secret key stored in a secret key holding unit and transferring the encrypted license information to a storage unit operable to hold license information whose security is ensured.

12. The program according to claim 11,
wherein said encrypting and transferring includes:
reading the encrypted license information and the secret key respectively from the storage unit and the secret key holding unit;
decrypting the read license information;
updating the decrypted license information in accordance with a use of digital content; and
encrypting the updated license information with the secret key and overwrite in the storage unit.

13. The program according to claim 12,
wherein the storage unit includes
a signature data storage subunit operable to hold data indicating a digital signature applied to a correspondence table indicating a correspondence between identification information which can identify the license information and information indicating an update history of the license information, and
further in said encrypting and transferring,
validity of the license information is verified based on data to which a digital signature is applied stored in the signature data storage unit and the correspondence table.
